(19) United States
(12) Patent Application Publication
(10) Pub. No.: US 2022/0178811 A1
(43) Pub. Date: Jun. 9, 2022

(54) Opto-Fluidic Apparatus for Individual Interrogation of Organisms

(71) Applicants: FUNDACIÓ INSTITUTE DE CIÈNCIES FOTÒNIQUES, CASTELLDEFELS, BARCELONA (ES); INSTITUCIÓ CATALANA DE RECERCA I ESTUDIS AVANÇATS, Barcelona (ES)

(72) Inventors: Valerio PRUNERI, BARCELONA (ES); Marc JOFRE, BARCELONA (ES); Pedro Antonio MARTÍNEZ CORDERO, BARCELONA (ES)

(21) Appl. No.: 17/594,451

(22) PCT Filed: Apr. 18, 2019
(86) PCT No.: PCT/ES2019/070270

§ 371 Date: Oct. 15, 2021

(51) Int. Cl. G01N 15/14

(52) U.S. Cl. CPC G01N 15/1404; G01N 15/1459; G01N 2015/0065; G01N 2015/1486; G01N 2015/1413

(57) ABSTRACT

The present invention relates to an apparatus for the detection of optical emission from individual members of a sample of micro-organisms where the flow is focused in a specific region, comprising an optical device including a light source configured to emit light in a first direction to individual members of the sample and a detection device configured to detect in a field of view optical emission from the individual members emitted in a second direction opposite to the first direction and excited by the light emitted by the light source and a fluid device including a storage reservoir configured to store the sample of micro-organisms, a pumping device, in particular, a circulation pump capable of producing different pulsed pressures to affect the flow configured to circulate the sample of micro organisms in the storage reservoir and wherein a capillary channel is arranged in the storage reservoir configured to allow a flow of individual members of the sample such that one individual member only is present in the field of view of the detection device at a given time of detection of the optical emission.

### TECHNICAL FIELD

The present disclosure relates to an apparatus for focusing flowing micro-organisms allowing the detection of optical emission from a sample, such as individual members of a sample.

### BACKGROUND AND SUMMARY

Detecting and analyzing micro-organisms is of importance in a variety of technical fields. Pulse-amplitude-modulation (PAM) fluorometers, flow cytometers and optical microscopy techniques are widely used in combination with fluorescence labeling for the analysis of biological micro-organisms (microalgae, bacteria, etc. . . . ). However, the techniques mentioned-above only offer accurate readings of a sub-set of measureable complementary biological parameters. For example, flow cytometers offer confident counting of present organisms and viability readings while PAM fluorometers offer precise reaction curves, photosynthetic activity and biological stress levels. Although optical microscopes allow for measuring a broad range of the parameters expressed above, they are of limited use for analyzing samples with very low concentrations of micro-organisms. They offer only a qualitative and poorly representative analysis because of the small field of view analyzed as compared with the entire sample volume. Furthermore, optical microscopy is suitable for laboratory studies but not for on-site measurements in the field. For example, optical microcopy has limited use in industrial plants and in the context of environmental water, food and drink quality testing. Thus, there is a need for a technology that allows for quantitative and representative analysis and measuring the range of parameters provided by the apparatuses mentioned above. Moreover, at the same time a portable solution for on-site measurements is needed.

Furthermore, the use of suspensions of micro-organisms in PAM fluorometers causes the problem of maintaining a homogeneous sample while reading and/or dealing with highly concentrated samples. Concentrations can vary from a few microorganisms per ml to 10⁹ microorganisms per ml. On the one hand, the accuracy of the results obtained by the measurements, in principle, can be affected by relatively high concentrations of micro-organisms. On the other hand, at low concentrations of micro-organisms it is encountered the difficulty of measurement because of the rapid depositing of relatively large (more than 10 μm in diameter) micro-organisms. Some PAM fluorometers are marketed with an optional accessory for stirring the sample within a cuvette while being in the emitter-detector volume. A stirring means can help to prevent cells from settling out of the suspension over the time-course of fluorescence measurements. However, complications while measuring highly concentrated samples, which produce masking effects to the optical signals, are not addressed by this method.

The PAM approach uses light pulses of 3000 to 10 000 mmol photons m⁻² s⁻¹ to modify fluorescence yields. Fast-repetition rate (FRR) PAM measures changes in fluorescence emission that occur during a short but intense light flash of 420 000 mmol photons m⁻² s⁻¹. Both PAM and FRR PAM fluorometers can be used to determine a range of fluorescence biological parameters.

By measuring the fluorescence levels resulting from different light pulses in real-time, active measures of detailed photochemistry are accessible. Energy absorbed from photons can be transferred to photochemistry, fluorescence, heat or other endpoints. Hence, when photochemistry is high, fluorescence is low. For instance, with F₀ denoting the fluorescence yield in the dark, when all reaction centers are open (mainly photochemistry), and Fₘ denoting the fluorescence yield when all reaction centers are closed (mainly fluorescence), (Fₘ-F₀)/Fₘ represents the efficiency of photosystem II, which could be defined as the fraction of absorbed photons whose energy is used in photosynthesis processes.

When micro-organisms flow inside a capillary channel, the channel has to be properly designed with respect to the dimensions and geometries of the same. For instance, the flow characteristic can be further controlled by sheath-flow focusing. The boundary layer effects of viscose fluids give rise to a boundary layer sheath flow and a relatively independent relatively ideal central flow. Inertial particle focusing within the capillary channel can be achieved by the proper choice of channel dimensions, channel geometry and the flow rate through the capillary channel

Inertial and elasto-inertial microfluidics, using Newtonian and non-Newtonian fluid, respectively, can provide further efficient single-particle flows in the center of the capillary channel and cell focusing that guarantees optimal sensitivity and accuracy in capillaries at a cost of throughput. Focusing by inertial microfluidics relies on the balance between shear-lift and wall-interaction forces, present in fluids at Reynolds numbers of about Re=1-100. Elasto-inertial microfluidics can provide further single-stream focusing at the center of straight channels only at moderate low fluid speeds.

Elasto-inertial microfluidics can be prepared by additives comprising biological or synthetic polymeric powders. For example, a 500 ppm polyethylene oxide (PEO) solution can be used to cause particles to be focused into a single-stream at the center of the channel (one particle flows after the other without flowing neighbored particles being present). In principle, focusing is achieved under specific conditions which depend on the flow rate, Reynolds number and ratio of the particle sizes to the channel diameter. Increasing the PEO concentration improves slightly the focusing and further reduces the flow rate, because of the relatively high pressure drop in the capillary channel

Moreover, machine artificial intelligence methods for data analysis can be applied to the detected signals provided by the above mentioned devices. The algorithms can be unsupervised, reinforced and supervised learning techniques.

It is an object of the present disclosure to provide a portable apparatus which allows focusing the micro-organisms flow into a particular region for the detection of optical emission from a sample, for instance, individual members of a sample of micro-organisms that alleviates the above-mentioned problems and allows for accurately and quantitatively measuring and analyzing a plurality of biological parameters from a sample comprising micro-organisms.

The present disclosure addresses the above-mentioned problems by providing an apparatus which focuses the flow of micro-organisms for the detection of optical (for example, fluorescence, scattering) emission (optical signals) from individual members of a sample (although not restricted to the detection of fluorescence and/or scattering emission from individual members only). The apparatus comprises an optical device including a light source configured to emit light in a first direction to individual members (micro-organisms) of the sample and a detection device configured to detect optical emission (optical signals) from the individual members (micro-organisms) emitted in a second direction opposite to the first direction and excited by the light emitted by the light source. The apparatus, furthermore, comprises a fluid device including a storage reservoir/tank configured to store the sample of micro-organisms and a pumping device, for example, a circulation pump, configured to circulate the sample of micro-organisms in the storage tank. The pumping device can be configured to produce pressure variations in the flow which change the velocity profile of the flow in a time period shorter than or about the time in which the fluid would reach a steady state before the pressure changes again (see also details on the aspect of pressure variations/pulses) described below). In other words, the pumping device can be configured to generate a pulsed flow of a portion of the sample of micro-organisms through the capillary channel.

A capillary channel is arranged in the storage tank configured to allow a flow of individual members of the sample such that one individual member only is present in the first field of view of the detection device at a given time of detection of the optical signal emission. The field of view corresponds to a particular portion of the capillary channel onto that the excitation light is radiated. The size of the field of view can be less than two times the diameters of typical micro-organisms of the sample. The capillary channel may extend in a direction perpendicular to the first direction. Suspended particles in a medium can be caused to flow along the capillary channel that may have at least one cross-sectional dimension smaller or about 100 μm and a longitudinal dimension larger than or about 10 mm.

For example, the excitation light is focused on a small excitation region located around a longitudinal axis of the capillary channel and well limited in the direction of this longitudinal axis such that one single micro-organism only can be present in that region at a given time. For this purpose, the optical device can have some collimation optics configured and arranged to focus light emitted by the light source onto the small excitation region that is located in the capillary channel. Data processing means of analyzing data provided by the detection device may be provided. Detected fluorescent events and scattering events can be correlated in post-processing in order to properly count only the population of events showing a unique fluorescence-scattering signature and discard others, in this way reducing significantly false positive counts that are produced, for example, by air bubbles, debris or similar artifacts. The thus specified apparatus allows for accurately measuring and analyzing a plurality of biological parameters from individual micro-organisms of a sample.

The apparatus may comprise a data processing device and algorithm for extracting parameters of the detected optical emission, wherein a concurrent analysis of the extracted parameters allows for adjusting any control parameters of operation of the apparatus, for example, pressure variations, flow rates, etc.

According to an embodiment, the detection device is additionally configured to detect in a second field of view different from the first field of view optical emission emitted in a third direction from a portion of the sample of micro-organisms stored in the storage tank. The second field of view is larger than the first field of view and covers a region, for example, a central region, in the storage tank different from a region covered by the first field of view. In this embodiment, some optics is provided in order to achieve the different fields of view. For example, the optical device of the apparatus may comprise a first lens configured and arranged to focus light emitted by the light source into the capillary channel and a second lens configured and arranged to focus light emitted by the light source into a region of the storage tank different from the capillary channel, such as in a central region of the storage tank.

The optical device may be configured for continuously emitting a light beam or for emitting light pulses. In an embodiment, the optical device may be configured to perform PAM fluorometry or FRR PAM fluorometry up to frequency of a few hundreds of MHz, for example. Accordingly, the detection device can be configured to have bandwidths from DC to a few hundreds of MHz.

In order to achieve a high sensitivity, the detection device may be provided with a microscope objective. The optical device of the apparatus, thus, may further comprise a microscope objective or other collimation optics configured and arranged to guide the optical signal emission that is to be detected toward a sensing surface of the detection device.

To allow for the detection of biological signatures while individual micro-organisms pass the field of view in the capillary channel, the flow of the individual micro-organisms through the capillary channel can be suitably controlled. Moreover, the geometry and dimensions of the capillary channel can be selected such that a flow of the individual members through the capillary channel allows for the detection of biological signatures while one single individual member of the sample is in the first field of view/excitation region in the capillary channel.

The circulation pump or any other extra pumping device allows for flow rate control, in a modulated fashion and active correction, for instance, to have a pulsed flow which allows for the manipulation of the hydrodynamic velocity profile inside the capillary channel which minimizes the later diffusion of the microorganisms out of the central line of the capillary due to the steady-state inertia forces imposed by the flow velocity profile. In an embodiment the flow device may comprise a fluid pump or combination of fluid pumps, for example, a bi-directional PID controlled peristaltic pump and a micro-dosage bi-directional pump.

Harmonically oscillating flow rates arises due to the pulsed pressure. From a physical standpoint, the fluid flow experiences both viscous resistance and inertia, the latter being due to the pulsations. This is in contrast to the steady-state Poiseuille paraboloid velocity profile wherein only viscous resistance is present.

The dimensionless Womersley number α=\sqrt{(h/2)²ω/ν} where h is the relevant hydraulic height of the channel, ω is the angular frequency of the oscillations and ν υ is the kinematic viscosity, may be interpreted as the inertial relaxation time at which the fluid reaches the steady state in response to an instantaneous change in the driving pressure. A critical Womersley number is given by α_{c}=α/γ₁ where γ₁ is the first root of the first order Bessel function which equals 2.4048 and α_{c} measures the fluid relaxation time in response to the rate of change of the pressure oscillation. For α_{c}<1 the fluid at all times reaches a steady state before changes happen to the pressure, and the fluid flow is quasi-steady. For α_{c}>1 the fluid does not reach a steady state before the pressure changes, and inertia becomes important. For α_{c}>1 the flow still has inertia acting in the opposite direction when the pressure gradient is reversed. Consequently, it will take some time before the pressure gradient can change the direction of the inertia. This introduces a phase shift between the fluid motion and the pressure gradient. However, at the confinement walls, the no-slip boundary condition enforces very low velocities with correspondingly low inertia such that fluid elements close to the walls have a smaller phase shift than fluid elements in the center of the confinement. At α_{c} larger or around 5 a full π phase shift is observed between the flow close to the walls and that at the center, forming a “fluidic skin effect” or annular region. The width of this region is given by the momentum diffusion length λ_{d} which can be found from the diffusivity of momentum and the characteristic time ω⁻¹ as λ_{d}=\sqrt{ν/ω}. The parabolic velocity profile in this annular region supports the notion that the flow here remains quasi-static for α_{c}>1. According to an embodiment the critical Womersley number for the flow of a portion of the sample of micro-organisms flowing through the capillary channel is larger than 1.

Furthermore, the elastic forces acting on the flow of the micro-organisms through the capillary channel means can be further controlled by adding visco-elastic polymers. Therefore, the fluid device of the apparatus may comprise means configured to supply a dosage of visco-elastic polymers to the sample stored in or supplied to the storage tank of the fluid device.

The light source may comprise coherent laser light, e.g. a laser diode or incoherent light, e.g. LED. Alternatively, the light source may comprise some other device. An excitation filter may be arranged between the light source and the storage tank if an LED device is used as the light source in order to provide for the appropriate excitation wavelengths. The detection device of the optical device may be a sensitive photomultiplier detector, APD, photon counter (e.g. multi-pixel photon counter), or complementary metal-oxide semiconductor, CMOS, sCMOS, eeCMOS, image sensor device or CCD sensor device, for example. The optical device may further comprise programmable data processing means for processing data provided by the detection device.

According to an embodiment, the micro-organisms comprise chloroplasts and the apparatus comprises data processing means connected to the detection device and configured to determine the efficiency of the photosystem II of the chloroplasts based on data provided by the excitation of the light source and detection device. The inventive apparatus can function as a cytometer and, for example, as a device for investigating or analyzing chlorophyll activity.

Furthermore, it is provided a method of detecting optical (for example, fluorescence or scattering) emission (optical signals) from individual members of a sample of micro-organisms. It comprises the steps of preparing the sample of micro-organisms and guiding a portion of the sample of micro-organisms through a capillary channel such that one single micro-organism only is present at a central portion (such as central about a longitudinal axis of the capillary channel) of the capillary channel at a given time, radiating in a first direction excitation light to only the central portion of the capillary channel at the given time in order to excite optical emission from the one single micro-organism and detecting the excited optical emission by a detection device, the excited optical emission being emitted by the single micro-organism at the given time in a second direction opposite to the first direction. The excitation light can be radiated, for example, by a PAM light source, in a pulse-modulated manner, such as a pulse-amplitude-modulated manner The central region can be sized in all dimensions such that no more than one micro-organism can be present in that region at a given time.

The sample of micro-organisms may be stored in a storage tank, the storage tank comprising the capillary channel and being operatively connected to a pumping device, for example, a circulation pump, and the preparing of the sample of micro-organisms may comprise adding a synthetic polymeric powder to the sample before storing it in the storage tank or to the sample stored in the storage tank.

According to an embodiment, the method is not restricted to the detection of biological signatures while individual micro-organisms pass the first field of view in the capillary channel one after the other but also comprises radiating in the first direction another excitation light to a portion, for instance, a central portion, of the storage tank wherein the capillary channel is not arranged in order to excite another optical signal emission from a portion of the sample of micro-organisms (located in the irradiated portion of the tank). The portion comprises a plurality of micro-organisms. According to this embodiment the method also comprises detecting the other optical emission excited in the portion of the sample of micro-organisms by the detection device, wherein the other optical emission excited in the portion is emitted in the second direction opposite to the first direction.

The above-described embodiments of the inventive method may be used for the investigation of chloroplasts and they may comprise determining the efficiency of the photosystem II of the chloroplasts based on data provided by the detection device.

According to an embodiment, the pumping device is operated to generate a pulsed flow of the portion of the sample of micro-organisms through the capillary channel.

Furthermore, according to an embodiment the critical Womersley number for the flow of the portion of the sample of micro-organisms through the capillary channel is larger than 1.

The above-described embodiments of the inventive method may be performed by one of the embodiments of the inventive apparatus described above. In all of the above-described embodiments of the inventive method and the inventive apparatus the detected data can be processed by artificial intelligence algorithms (for example with machine learning techniques). Post-processing aims to analyze the optical signals (from fluorescence and scattering events acquired in the detector), translate them in optical signatures (based on the amplitude and duration of the events), generate and perform training of models, characterize and match the acquired signals with models of target microorganism populations and distinguish them from signatures of spurious artifacts (different of target microorganism) in the sample, allowing to discard spurious signals population and minimize the false positives counts. The above-described method steps can be performed by the apparatus according to one of the above-described embodiments.

Additional features of the present disclosure will be described with reference to the drawings. In the description, reference is made to the accompanying figures that are meant to illustrate certain embodiments of the disclosure. It is understood that such embodiments do not represent the full scope of the disclosure.

### BRIEF DESCRIPTION OF THE FIGURES

FIG. 1 schematically illustrates a system for focusing flowing particles and optically interrogating individual members of a sample in accordance with an exemplary embodiment of the disclosure.

FIG. 2 is a pictorial depiction of the fluid flow velocity profiles for two different pulsed flowing conditions.

FIG. 3 is a collection of graphs showing experimental values of the detection of different sized polystyrene microspheres particles (histogram of the peak values of detected voltages) in a liquid solution. The bars indicate the frequencies of occurrence.

FIG. 4 illustrates a method of detecting optical emission from individual members of a sample of micro-organisms according to an embodiment of the present disclosure.

FIG. 5 schematically illustrates an apparatus comprising an optical device including a light source and a detection device and further comprising a fluid device including a sample storage tank wherein a capillary channel is formed according to an embodiment of the present disclosure.

FIGS. 6a-6b illustrate an investigation of photosystem II activity by a method according to an embodiment of the present disclosure.

### DETAILED DESCRIPTION

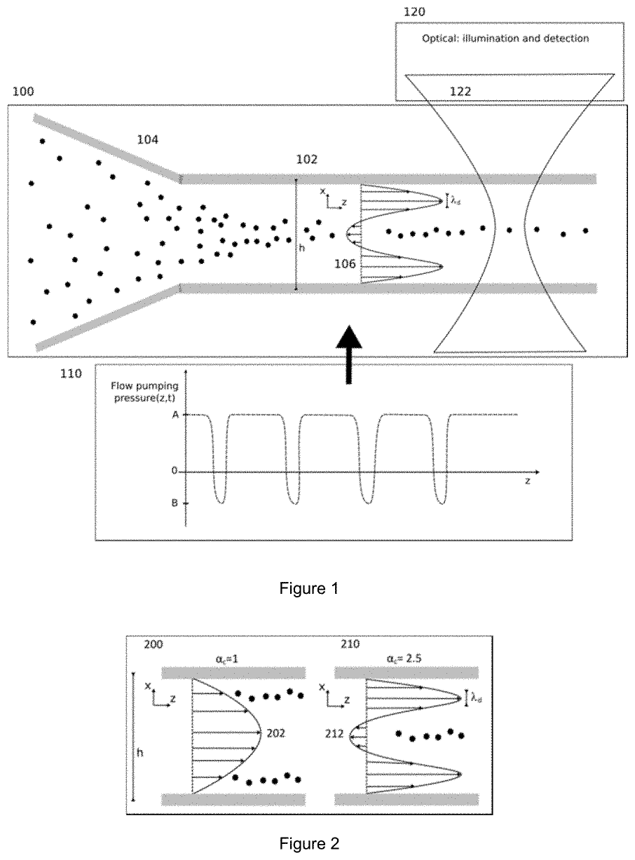

The present disclosure provides an apparatus that allows for focusing micro-organisms for an accurate detection of optical emission (optical signals) from individual members of a sample. FIG. 1 illustrates an embodiment of such an apparatus 100 with a pulsed driving pressure (see 110 in FIG. 1) and an optical illumination/detection apparatus 120. In order to achieve hydrodynamic focusing using the pulsed regime α_{c} has to be larger than 1 and at least one period of the pulsation has to be propagating inside the channel to largely avoid the generation of turbulence in the channel The period T of the pulses is equal to the linear flow speed divided by the pulsed frequency.

For example, in the apparatus 100 the channel 102 is about 50 mm in length and a squared cross-section has dimensions of 75 μm. A linear liquid flow 110 with a speed of 0.1 meters per second and a pulsed frequency of 10 Hz may be applied In this case, the Womersley number is 4.85, the critical Womersley is around 2.02 and the period of the propagating pulsation is 10 mm. Furthermore, the entry 104 to the capillary channel can have a conical shape to allow for reducing turbulence transition into the capillary channel

The applied flow pressure 110 allows for the fluid to have a positive net transport with a baseline pressure level indicated by A. At given pulsed frequency the pressure is rapidly reversed in direction indicated with a negative level B. However, over the entire pressure cycle a positive fluid flow momentum is maintained.

The generated flow velocity profile 106 is not a paraboloid but rather a depression is formed in the center of the velocity profile 102 in the capillary channel The velocity profile is further explained below. A single stream of micro-organisms is flowing in the center of the capillary channel which allows for individually detecting the micro-organisms by means of an optical technique. In an embodiment, the optical apparatus 120 has means to generate a narrow illumination and detection spot 122.

Hence, an oscillatory or pulsed flow regime (presumed to be laminar and incompressible) in a capillary channel allows for focusing the micro-organisms in the center of the channel capillary.

Specifically, in FIG. 2 the physical flowing phenomena are first explained for a non-focusing micro-organisms regime 200, where α_{c}=1. The axial velocity profile for a liquid with no-slip boundary condition driven by a pressure difference in a channel is indicated by 202. The velocity profile 202 represents a Poiseuille paraboloid. The fluid at all times reaches a steady state before changes happen to the pressure. The velocity profile forces the particles to be located around 0.6 times the half height cross-section of the center of the channel. Then, in FIG. 2 the physical observations are illustrated for a focusing micro-organisms regime 210 where α_{c}=2.5. The effect of inertia on the velocity profile is clearly observable for α_{c}>1 by the deviation from the Poiseuille paraboloid 212. The diffusion length λ_{d}=\sqrt{υ/ω} (υ denotes the fluid velocity and ω denotes the pulse frequency) giving the width of the quasi-steady annular region is indicated. The fluid does not reach a steady state before the pressure changes and inertia becomes important. The velocity profile deviation from a paraboloid allows for particles being focused around the center of the channel.

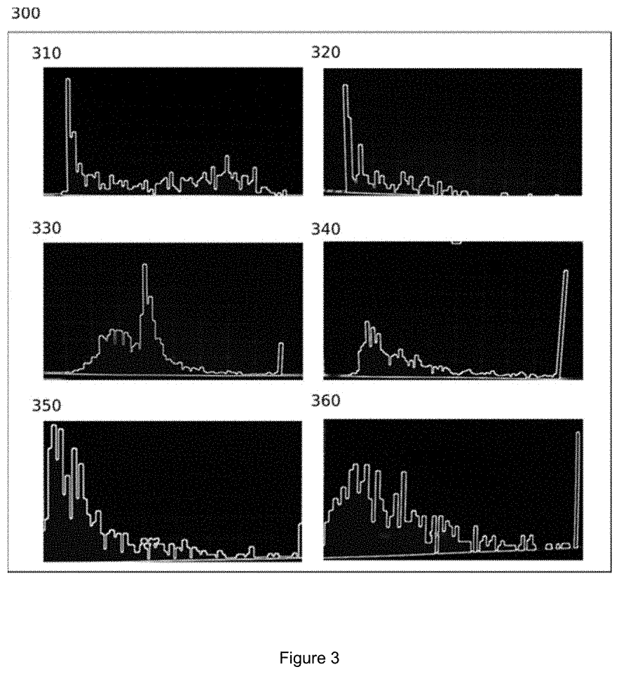

For the purpose of explanation, FIG. 3 shows data measured experimentally and presented in the form of voltage histograms. The horizontal axes (the scaling is not representative) represent the voltage bins of the height of the detected optical pulses. The vertical axes represent the normalized frequencies of occurrence so that the most probable voltage values are clearly identified. Reference sign 310 designates a histogram for 50 μm particle beads in a pulsed flow regime obtained using apparatus 100. Reference sign 320 designates a histogram of 50 μm particle beads in a non-pulsed flow regime. Reference sign 330 designates a histogram of 10 μm particle beads in a pulsed flow regime obtained using apparatus 100. Reference sign 340 designates a histogram of 10 μm particle beads in a non-pulsed flow regime. Reference sign 350 designates a histogram of 2 μm particle beads in a pulsed flow regime obtained using apparatus 100. Reference sign 360 designates a histogram of 2 μm particle beads in a non-pulsed flow regime.

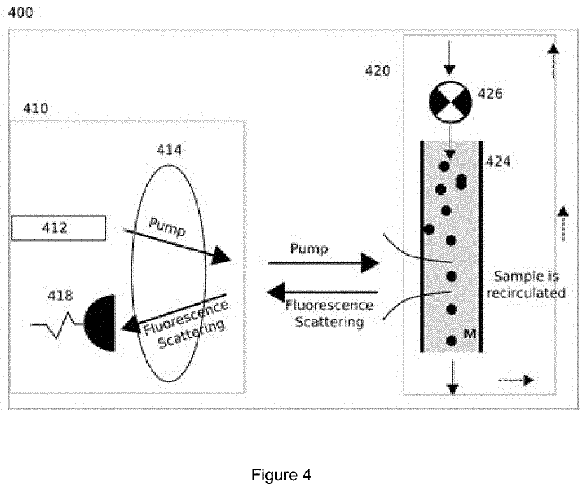

The apparatus 400 shown in FIG. 4 comprises an optical device 410 and a fluid device 420 for providing a sample S comprising micro-organisms M. The optical device 410 comprises a light source 412, for example, comprising a laser device. In general, wavelengths from the ultraviolet to the infrared range of the light spectrum depending on the excitation wavelength required for each specific application. Output powers of a few mW may be chosen.

Light emitted in a first direction by the light source 412 is collimated by a lens 414. Further, a detection device 418 is provided in order to detect fluorescence emission excited in the sample S. The detection device 418 is arranged to detect fluorescence emission or scattering emission radiated in a second direction that is opposite to the first direction. The detection device 418 may be a sensitive photodiode (APD, photomultiplier, multi-pixel photon counter), CCD sensor device or an image sensor device, and it may be equipped with an interferential filter or/and an absorption filter.

The fluid device 420 providing the sample S comprises a capillary channel 424 which is a small tube of a circular or square cross section and may comprise plastic, glass, or fused quartz (for UV light) material and may be designed to allow fluid to flow along the longitudinal axis of the channel The capillary channel 424 may have a relevant hydraulic height of about 100 μm, for example.

Due to the operation of the circulation pump 426, operating as in apparatus 100, a continuous or pulsed flow of the sample S for testing the same can be provided. It goes without saying that the circulation pump 426 may operate on a portion of an entire sample or on the entire sample.

The collimation lens 414 of the optical device 410 focuses the light emitted by the light source 412 of the optical device 410 into the capillary channel 424, for example, a central portion of the capillary channel 424. The capillary channel 424 may extend in a direction substantially perpendicularly to the optical axis of the first collimation lens 414. The central portion corresponds to the narrow field of view (for example, with a diameter of a few microns) of the detection device 418 of the optical device 410.

Moreover, the flow of micro-organisms M through the capillary channel 424 is controlled such that the one micro-organism that is detected at a given time in the field of view.stays long enough (for example, a few hundred μs) in the field of view in order to have the detection device 418 detecting desired biological signatures from the micro-organism (see also description below). Thus, the biological signatures of individual micro-organisms can be detected independently of the concentration of the micro-organisms M in the sample S and a plurality of parameters can be derived from the detection results given by the detection device 418 by means of some data processing means. The fluorescence emission from the micro-organism depends on the actual biological vitality. Examples of the parameters inter alia comprise reaction curves, photosynthetic activity and biological stress levels.

The optical device 410 of apparatus 400 can be configured to perform PAM fluorometry or FRR PMA fluorometry up to frequency of a few hundreds of MHz, for example. In this configuration, the apparatus 400 is suitable for the investigation of photosynthesis. By studying the fluorescence yield arising from phytoplankton chlorophyll, for example, one can determine many characteristics related to other internal processes of the chlorophyll cells. In the context of PAM fluorometric investigations on photosynthesis of chlorophyll cells (chloroplasts) the detection device 418 can gather information on two levels of light, namely, low and high levels.

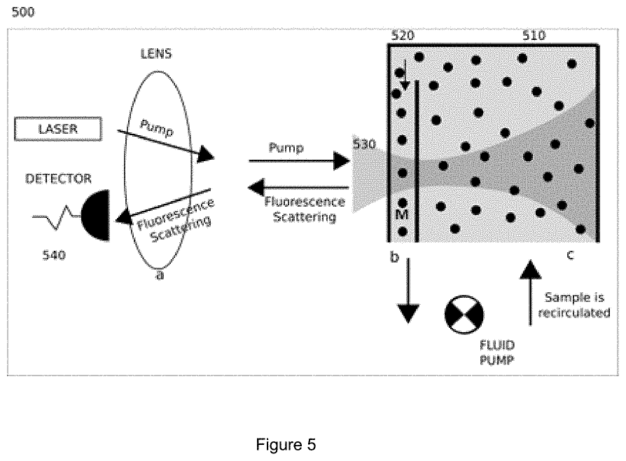

FIG. 5 illustrates an apparatus of detecting optical emission from individual members of a sample of micro-organisms according to an embodiment of the present disclosure. A sample comprising a plurality of micro-organisms is prepared and it is stored in a reservoir 510. Preparation of the sample may partially be performed in that reservoir. Preparation of the sample of micro-organisms may comprise filtering and/or purifying a raw sample, for example, by means of concentration filters and an appropriate chemistry including, for example, acids, flocculators, etc.). Particulate concentrators in the form of disposable ultrafiltration devices with polymer membranes may be used for the concentration and/or purification of biological raw samples in order to prepare the sample.

A portion of the prepared sample is supplied to a capillary channel 520 formed in the reservoir. A portion of the capillary channel 520 is irradiated by light 530 from a light source (for example, a laser) emitting excitation light towards the capillary channel 520 in a first direction. The excitation light is focused to the portion of the capillary channel 520 by some collimation optics, for example, comprising a lens.

The excitation light causes optical emission from a micro-organism (thanks to its auto fluorescence behavior or because it has been labelled with a reagent having fluorochromes) being present in an excitation region of the capillary channel 520 that is irradiated by the light source. The capillary channel 520 and the flow through the capillary channel are designed such that only a single one of the plurality of micro-organisms is present in the portion of the capillary channel 520 that is irradiated by the light source at a given time of detection, i.e., the excitation region. At the given time of detection, the excited optical emission (optical signals) of the single micro-organism is detected by a detection device 540. The optical emission may be detected via some collimation optics, for example, a microscope objective. The optical emission detected by the detection device 540 is radiated in a second direction opposite to the first direction of emission of the excitation light. Subsequently, biological parameters can be derived from the detected optical emission.

As already mentioned, a portion of the prepared sample is supplied to the capillary channel 520 formed in the reservoir 510. The flow through the capillary channel 520 should be controlled such that only a single one of the plurality of micro-organisms is present in the portion of the capillary channel 520 that is irradiated by the light source at a given time of the detection device 540. The flow, in addition, has to be slow enough to allow for the detection of a meaningful biological signature from the micro-organism. To achieve such a flow a circulation pump is properly controlled to operate in order to supply a portion of the sample to the capillary channel 520.

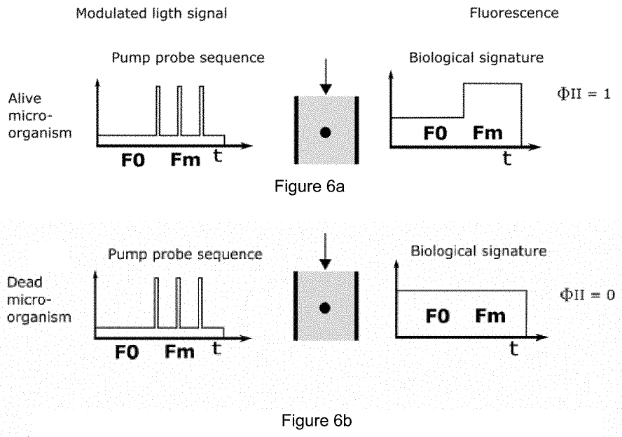

In certain embodiments, measurements can be performed based on the PAM technique. Investigations on photosynthesis of chlorophyll cells, for example, can be carried out by the described operation. In this context FIGS. 6a-6b show an exemplary time sequence of optical interrogation by PAM measurements for two cases of detected biological signatures corresponding to F₀ being the fluorescence yield in the dark, when all reaction centers are open (mainly photochemistry), and Fₘ being the fluorescence yield when all reaction centers are closed (mainly fluorescence).

In operation of the apparatus 500 shown in FIG. 5, modulated excitation light (pump wave) can be radiated (see FIGS. 6a-6b) on a particular single micro-organism (chlorophyll cell) being in a target portion/excitation region (shown in FIGS. 6a-6b) of the capillary channel corresponding to a field of view of the detection device. Pump probing sequences with alternating F₀ and Fₘ are shown in FIGS. 6a-6b. In the shown example, the total optical probe sequence may have a duration of about 500 μs and the detection time needed for observing a biological signature concurrent with the illumination is also about 500 μs. Furthermore, the probing optical beam diameter and the field of view are about 50 μm. The linear flow speed of the individual micro-organisms through the capillary channel can suitably be adjusted to 0.1 m/s, for example. By using visco-elastic polymers it is made possible to focus, in the fluid, micro-organisms in the center of the capillary channel

The response/biological signature as detected from the excited fluorescence emission of the micro-organism (chlorophyll cell) is shown in the right column of FIGS. 6a-6b. In the case of a detected living organism a signature indicating a photochemical efficiency Φ_{II}=1 is observed (FIG. 6a) whereas in the case of a detected dead organism a signature indicating a photochemical efficiency Φ_{II}=0 (equal levels of F₀ and Fₘ) is observed (FIG. 6b). The organisms that are present in the sample can be counted individually when they are passing the above-mentioned portion of the capillary channel/field of view of the detection device.

All previously discussed embodiments are not intended as limitations but serve as examples illustrating features of the disclosure. It is to be understood that some or all of the above-described features can also be combined in different ways.

1. An apparatus for detection of optical emission from individual members of a sample of micro-organisms, comprising
an optical device including a light source configured to emit light in a first direction to individual members of the sample and a detection device configured to detect in a first field of view optical emission from the individual members emitted in a second direction opposite to the first direction and excited by the light emitted by the light source; and
a fluid device including a storage tank configured to store the sample of micro-organisms, a pumping device configured to circulate the sample of micro-organisms in the storage tank and wherein a capillary channel is arranged in the storage tank configured to allow a flow of individual members of the sample such that one individual member only is present in the field of view of the detection device at a given time of detection of the optical emission.

2. The apparatus according to claim 1, wherein the pumping device is configured to produce pressure variations in the flow.

3. The apparatus according to claim 1, further comprising a data processing device and algorithm for extracting parameters of the detected optical emission, wherein a concurrent analysis of the extracted parameters allows for adjusting any control parameters of operation of the apparatus and reduction of false positive counts by means of artificial intelligence algorithms.

4. The apparatus according to claim 1, wherein the detection device is additionally configured to detect in a second field of view different from and larger than the first field of view other optical emission emitted in the second direction from a portion of the sample of micro-organisms stored in the storage tank.

5. The apparatus according to claim 4, wherein the optical device further comprises a first lens configured and arranged to focus light emitted by the light source into a particular region of the capillary channel and a second lens configured and arranged to collect light emitted by the micro-organisms of the storage tank different from the capillary channel.

6. The apparatus according to claim 1 wherein the optical device is configured to perform pulse-amplitude-modulation fluorometry or fast-repetition-rate pulse-amplitude-modulation fluorometry.

7. The apparatus according to claim 1, wherein the optical device further comprises a microscope objective arranged to guide the optical emission toward a sensing surface of the detection device.

8. The apparatus according to claim 1, further comprising a control means configured to control operation of the pumping device and wherein a) the geometry and dimensions of the capillary channel are selected and b) the control means is configured to control operation of the pumping device such that that a flow of the individual members through the capillary channel allows for the detection of biological signatures while one single member of the sample only is in the first field of view.

9. The apparatus according to claim 1, further comprising means configured to supply a dosage of visco-elastic polymers to the sample.

10. The apparatus according to claim 1, wherein the micro-organisms comprise chloroplasts, light emission modulated control and further comprising data processing means connected to the detection device and configured to determine an efficiency of a photosystem II of the chloroplasts based on data provided by the detection device.

11. A method of detecting optical emission from individual micro-organisms of a sample of micro-organisms, comprising the steps of:
preparing the sample of micro-organisms;
guiding a portion of the sample of micro-organisms through a capillary channel such that one single micro-organism only is present at a central portion of the capillary channel at a given time;
radiating in a first direction excitation light to only the central portion of the capillary channel at the given time in order to excite optical emission from the one single micro-organism; and
detecting the excited optical emission by a detection device, the optical emission being detected in a second direction opposite to the first direction.

12. The method according to claim 11, wherein the excitation light is radiated in a pulse-modulated manner.

13. The method according to claim 11, wherein the guiding of the portion of the sample of micro-organisms through the capillary channel comprises moving the portion of the sample of micro-organisms by means of a pumping device.

14. The method according to claim 13, further comprising storing the sample of micro-organisms in a storage tank, the storage tank comprising the capillary channel and being operatively connected to the pumping device.

15. The method according to claim 12, wherein the preparing of the sample of micro-organisms comprises adding a synthetic polymeric powder to the sample before storing the sample in a storage tank or adding the synthetic polymeric powder to the sample stored in the storage tank.

16. The method according to claim 14, further comprising
radiating in the first direction another excitation light to a portion of the storage tank wherein the capillary channel is not arranged in order to excite other optical emission from a portion of the sample of micro-organisms, the portion comprising a plurality of micro-organisms; and
detecting the other optical emission excited in the portion of the sample of micro-organisms.

17. The method according to claim 11, wherein a pumping device is operated to generate a pulsed flow of the portion of the sample of micro-organisms through the capillary channel.

18. The method according to claim 11, wherein the critical Womersley number for the flow of the portion of the sample of micro-organisms flowing through the capillary channel is larger than 1.

19. The method according to claim 11, wherein the micro-organisms comprise chloroplasts and further comprising determining the efficiency of the photosystem II of the chloroplasts based on data provided by the detection device.

20. The method according to claim 11, wherein the method steps are performed by an apparatus for detection of optical emission from individual members of the sample of micro-organisms, comprising
an optical device including a light source configured to emit light in the first direction to individual members of the sample and a detection device configured to detect in a first field of view optical emission from the individual members emitted in the second direction opposite to the first direction and excited by the light emitted by the light source; and
a fluid device including a storage tank configured to store the sample of micro-organisms, a pumping device configured to circulate the sample of micro-organisms in the storage tank and wherein the capillary channel is arranged in the storage tank configured to allow a flow of individual members of the sample such that one individual member only is present in the field of view of the detection device at a given time of detection of the optical emission.

21. The apparatus according to claim 1, wherein the pumping device is a circulation pump.

22. The method according to claim 12, wherein the pulse-modulated manner is a pulse-amplitude-modulated manner.
